(19) United States
(12) Patent Application Publication
(10) Pub. No.: US 2009/0181151 A1
(43) Pub. Date: Jul. 16, 2009

(54) Soybean Paste 2C and Method for Preparing Thereof

(76) Inventors: Sergey Borisovich Osipenko, Kiev (UA); Stanislav Evgenievich Lesnikov, Kiev (UA)

Correspondence Address: ABELMAN, FRAYNE & SCHWAB, 666 THIRD AVENUE, 10TH FLOOR, NEW YORK, NY, 10017, US

(21) Appl. No.: 12/086,821

(22) PCT Filed: Dec. 29, 2005
(86) PCT No.: PCT/UA2005/000059

§ 371 Date: Oct. 30, 2008

(30) Foreign Application Priority Data
Dec. 16, 2005 (UA) A 2005 12134

(51) Int. Cl. A23J 3/16; A23L 1/20

(52) U.S. Cl. 426/634; 426/507

(57) ABSTRACT

A set of invention relates to soy-bean based-food products and to methods for producing pastes and farces by grinding and heat-treating vegetable raw material. The inventive soy-bean paste 2C is embodied in the form of an aqueous suspension of fine natural soya beans, comprises, at a water/soya bean mass ratio equal to 1:(2-6), protein, fats, including polysaturated fatty acids, carbohydrates, vitamins and microelements and is characterised in that it exhibits a greater vitamin access rate in comparison with natural soya beans, in particular (in mg/100 g of soya beans) PP vitamin not less than 6.0 and B2 vitamin not less than 0.35, wherein the fat content, in which the quantity of polysaturated fatty acids ranges from 55 to 62 mass %, corresponds to the soya bean fat content. The inventive method for producing the 2C paste is based on a hydrodynamic action produced on beans in a liquid by forcedly circulating components through a closed reservoire-pump-nozzle-reservoire circuit associated with degassing and consists in turbulating and cavitating a medium in such a way that a hot suspension is obtained, wherein the circulation is carried out during 240-280 cycles until a paste is formed, degassing is carried out for 1-10 seconds after the exposure of the beans to the hydrodynamic action by depressurising a mixer, whose free volume is filled with the liquid, in holding the mixture heated to a temperature of 100-112° C. for 5-30 minutes and in discharging said mixture for packing or in cooling it.

### BACKGROUND OF THE INVENTION

1. Field of the Invention

The invention relates to food production, particularly to the production of food from leguminous seeds, particularly, from soybeans. More specifically, the invention relates to a soybean product as paste ready to eat and to a half-finished material obtained by breaking and heat processing soybeans and optionally other raw material.

2. Discussion of Background

It is known (cf. www.soyka.ru) that a soybean consists of cellular structures covered with a wall (cellulose) and containing cytoplasm, i.e. a medium carrying the whole combination of nutrients that are necessary for a soybean to be adequately digested. The content of the cellular structure, as is the case when beans are boiled, is practically inaccessible for human digestion.

It is also known that soybeans contain non-nutritives, i.e. urease and trypsin inhibitor. These interfere with the normal digestion of soybeans, they have an adverse effect on reproductive function, etc. These harmful substances are usually-inactivated by a heat treatment (generally above 100° C.).

Heating of pasty foods with a high content of proteins to a high temperature is technically difficult to realize. To do this, use is generally made of costly scraped-surface double-pipe enclosed heat exchangers.

Heating of a soybean paste throughout to a required temperature inevitably results in overheating of a considerable portion of the paste at the heated surface. Overheating causes thermal decomposition of vitamins, proteins, especially sulfur-containing amino acids, polyunsaturated fatty acids, etc.

A search for a trade-off of a decrease in the content of non-nutritives to undangerous levels against retention of beneficial constituents of soybeans, including vitamins, to a maximum is a complicated, presently unresolved problem. It must be emphasized that there are fundamental differences between vitamins found naturally in soybeans and synthetic vitamins added to soybean paste as dietary supplements. Nutritionists increasingly claim that synthetic vitamins are poorly digestible (indeed harmful), therefore the present invention is directed solely to the constituents of soybeans found naturally in them.

The problem becomes more involved because data on the composition of soybeans found in the literature are based on the results of laboratory analyses made by the procedures wherein dry soybeans are crushed and reduced to powder, e.g., in colloidal mills. The powder is then diluted with plenty of a liquid to let the soybean constituents pass into solution. The process is enhanced by adding a small amount of an acid. The solution thus obtained is examined by optical or chemical methods. The result is calculated as the dry weight of soybeans. It is clear that the analysis for the composition of soybeans depends on the degree of soybeans reduction in size, i.e., on the degree of availability of the contents (cytoplasm) of a soybean cell (here appropriate is an analogy with hazelnut kernels, e.g., the vitamins of which are unavailable unless their coat is broken down).

The notion of availability can be represented by an availability value k obtained from the expression

k=M₂/M₁, where

M₂ is the content of a vitamin (vitamin yield) in soybean paste, expressed in mg/100 g,

M₁ is the content of the vitamin in raw soybeans, expressed in mg/100 g.

Methods of preparing soybean pastes are well known in the art. Generally, such methods comprise the steps of soaking soybeans in water, cooking them at a temperature ranging from 110° C. to 120° C., then milling the cooked beans wet, and putting them through a thermal process under high pressure as is the case in the manufacture of canned fish (cf. C. C. A [symbol] aMeHb, B. [symbol] . C [symbol] Kapb<<Co [symbol] : npoMblW [symbol] eHHa [symbol] nepepa6OTKa, KOpMOBble [symbol] o6aBK [symbol] , npo [symbol] yKTbl n [symbol] TaH/ [symbol] >>, K. <<Hopa-np [symbol] HT>>2003 475 CT.—S. S. Adamen, V. I. Sichkar “Soy: Industrial Processing, Feed Additives, Foods”—Kyiv, Nora-Print Publishers, 2003, p. 475 (in Russian)).

These methods suffer from many disadvantages such as a rather lengthy soaking of the soybeans in order to hull them and to subsequently mill them with a lower input of energy. Also, the thermal process causes thermal breakdown of protein with the resulting formation of carcinogens, oxidation of fats, i.e., polyunsaturated fatty acids turn saturated, and the product becomes rancid. The soaking and hulling of the soybeans results in the loss of water-soluble protein fractions, sugars and starch, the washout of vitamins and trace elements, the loss of dietary fiber (all in all, 12-18% of dry matter). The tail water containing these substances must be treated in costly water purifiers, must be chemically cleaned with a consequent increase in capital expenditure and an ecological hazard.

To produce pastes from whole beans, use is made of conventional food-processing equipment of canneries, such as cookers, cutters, dispersators, etc.

Presently the best prior art soybean paste is that disclosed in RU 2216207 C2, A 23L 1, A 23L 1/48, A 23J 1/14, 2003 and prepared by the method consisting in simultaneous comminuting, mixing, homogenizing, and heat treatment of soybeans in a rotary dispersing apparatus wherein an acoustic field of 100 W through 500 W per kilogram of the product is established.

The prior art soybean paste contains from 50% to 77% soybean concentrate, i.e., soybean paste produced as above outlined, and from 26% to 35% by weight dry matter, soybean oil, fillers, sugar.

The fillers are fed to the rotary dispersing apparatus once the soybean concentrate has been prepared (the soybean paste, which is a dispersion of soybeans in water, has been designated “soybean concentrate”).

The soybean paste closely bearing on soybean paste 2C is an emulsion containing protein, fats, carbohydrates, vitamins, micro- and macronutrients; it is savory and is useful in therapy and prevention of some health disorders.

However, the food product prepared by the above outlined method suffers from some disadvantages, which limit the product utility.

In particular, soybeans are processed in the rotary dispersing apparatus at a temperature within the range of 85° C. to 95° C. For this purpose, the apparatus is pre-filled with hot water and the other ingredients are added immediately following the comminuting of the beans. Such temperature conditions prevent the content of the non-nutritives inherent in soybeans from being decreased to undangerous levels.

Specifically, urease and trypsin inhibitor present in soybeans in amounts that are dangerous to health cannot be inactivated to undangerous levels.

Moreover, the content of vitamins in the prior art paste as disclosed in the specification is significantly less compared to that found naturally in soybeans. For example, the amount of vitally important vitamin PP (Niacin) is more than three times less (in terms of the dry weight of soybeans contained in the paste), vitamin B₆ (Pyridoxine) is less by more than 30%.

To add other ingredients following the preparation of the paste, the apparatus must be depressurized. As this takes place, a significant amount of atmospheric oxygen enters the apparatus with resulting oxidation of vitamins and unsaturated fatty acids such as linolic and linolenic acids. These acids are vitally important in foods intended for health maintenance and when oxidized adversely affect digestion.

The disadvantages discussed above are obviated in a method underlying the invention of a method for preparing soybean paste 2C. The prior method is for preparing stable dispersions by mixing, comminuting, and heating soybeans in a circulation circuit wherein a stream of soybeans in a liquid experiences turbulence and cavitation (RU 2207449, F15D 1/02, 20; application 2001122036 filed Aug. 8, 2001 for “Device for acting on a fluid stream,” inventor S. B. Osipenko).

In the prior art method, soybeans are acted upon by hydrodynamic forces while being force circulated in a liquid through a closed circuit comprising a vessel, a pump, and a structural member, all connected in series, wherein a pump is continuously forcing the liquid through the circulation circuit. The circulation circuit is provided with means for setting up turbulence and cavitation in the liquid flow and means for degassing the liquid to thereby achieve supercavitation and remove excessive air and chlorine from the liquid with consequent preclusion of oxidation of the product.

While soybeans in a liquid are circulated in a closed circuit, they are finely divided to form a heated suspension with substantially all structural constituents of the soybeans retained.

A disadvantage of the prior art method resides in the fact that the method is performed in a multi-purpose equipment, which can be run under operating conditions that are not optimized for the production of the suspension of desired nutritional quality and physical properties.

### SUMMARY OF THE INVENTION

An object of the invention is to provide soybean paste 2C wherein the degree of vitamin availability is greater than one, or more particularly, such paste wherein vitamins “yield” exceeds the content of those same vitamins found naturally in soybeans with the amounts of and relationships between other nutrients retained.

This object is achieved by the provision of soybean paste 2C as a suspension of finely divided soybeans in water, the suspension comprising proteins, carbohydrates, vitamins and microelements, fats, polyunsaturated fatty acids included, wherein the water-soybeans weight ratio based on moisture-retaining power of proteins being 1:(2-6) and vitamin availability, k=M_{2/}M₁, in terms of the dry weight of the paste being k>1, wherein

M₁ is the content of a vitamin in soybeans and

M₂ is the content of the vitamin in soybean paste 2C .

In particular, the paste of the invention contains vitamin PP in the amount of at least 6.0 mg/100 g of dry product and 0.35 mg/100 g vitamin B₂, while the content of polyunsaturated fatty acids, which ranges from 55% to 62% by weight, corresponds to the fat content found naturally in soybeans.

This object is also achieved by the provision of a method for preparing soybean paste 2C by the exposure of unprocessed soybeans in a liquid to hydrodynamic forces acting on the soybeans in a liquid being circulated in a closed forced circulation air-tight circuit comprising a vessel, a pump, and a structural member, with turbulent flow and cavitation being caused in the soybeans in a liquid, whereby a heated suspension is obtained. According to the invention, the soybeans in a liquid are exposed to the hydrodynamic forces in the closed forced circulation circuit for 280 through 450 cycles, wherein, within 1 to 10 seconds of the exposure, the suspension is degassed by lessening pressure in the vessel and simultaneously displacing the gas produced therein with a liquid, and once the suspension has attained the temperature of 100° C. to 112° C., it is held in the air-tight vessel for 5 to 30 minutes, whereafter the suspension is discharged for packaging or subjected to natural or forced cooling.

In the method outlined above, where soybean paste, with the water-soybeans weight ratio of 1:(2-6), is obtained, protein and combined water (up to 13% by weight) are retained, while the soybeans are being dispersed, to provide for the formation of a stable suspension in absence of atmospheric oxygen, wherein the soy particles (a dispersed phase) constitute a three-dimensional structure and water (a dispersion medium) is found in the cells of the structure.

The resulting food product is soybean paste 2C having good taste and color, high organoleptic qualities and stable consumer properties such as form, plasticity, spreading capacity. The product is characterized by distinct nutritive properties as well as medicinal and disease preventive properties.

Soybean paste 2C of the invention features the balance of nutritives inherent in unprocessed soybeans, all being required for adequate digestion, an increase in the degree of vitamin availability and inactivation of non-nutritives naturally found in soybeans.

The method of the invention can be realized in the apparatus disclosed in RU Utility Model No. 9572 “Apparatus for the heat treatment of liquid media” issued upon application No. 98119690 of Nov. 3, 1998 (inventor S. B. Osipenko). The process of preparing soybean paste is continued until the processed material is heated to 100° C. through 112° C. During the processing, the temperature of the material being processed continuously rises throughout the material to 100° C. through 112° C., the material is finely divided, mixed and dispersed to thereby inactivate trypsin inhibitor and the prepared product is held in the vessel to do away with protein flavor.

A “mild” heat treatment of the processed material without recourse to heating surfaces precludes thermal breakdown of nutrients, particularly vitamins, and preserves the unique natural balance: protein-fats- carbohydrates-vitamins-microelements. While the material is being processed, there occurs a substantial increase in the availability of vitamins, fats, amino acids and other beneficial constituents of soybeans. This is due to the destruction of hard walls of the soybean cells, egress of their contents (cytoplasm) therefrom and into the liquid, thus providing for adequate digestion of soybean paste 2C by a living being.

The degassing step performed during the circulation of the processed material and consisting in displacing the gas produced therein with a liquid is useful in preventing a fresh portion of atmospheric air from entering the vessel and thus precluding oxidation of vitamins and fats and retaining the content of polyunsaturated fatty acids substantially equal to that naturally found in soybeans. This is unachievable in the prior art methods.

In the method of the invention, soybeans are comminuted, get heated and mixed simultaneously to thereby provide for a decrease in specific energy expenditures by 25% to 30%.

Hydrodynamic forces acting on the soybeans in a liquid circulated in the range of 280 to 450 cycles, which are manifested as pressure fields due to cavitation and as turbulent shear forces, destroy hard walls of the soybean cells, the cells' contents (cytoplasm) pass into the liquid without thermal destruction and are available for adequate digestion, so that an increase in vitamins “yield” or the degree of their availability (bioavailability) should be understood in this very sense.

The present invention can be carried out in the apparatus disclosed in Russian Certificate for Utility Model No. 9572 “Apparatus for the heat treatment of liquid media” issued upon application No. 98119690 of Nov. 3, 1998 (inventor S. B. Osipenko), which apparatus implements the processing procedure disclosed in Russian Patent No. 2,207,449 “Device for acting upon a fluid flow” issued upon application No. 2001122036 of Aug. 8, 2001 (inventor S. B. Osipenko). The apparatus for carrying out the method of the invention comprises a vessel provided with a lid and included in a closed circuit further comprising a pump and a pressure pipe line tangentially attached to the upper portion of the vessel and provided with a structural member capable of setting up turbulence and cavitation in the liquid flow.

A measured batch of beans, washed and free from impurities, is charged into the vessel while the lid is open and the vessel is filled up with water. The lid is then put down and the pump brought into operation.

With the pressure pipe line attached tangentially to the vessel, the liquid flow in the vessel is set in a helical motion directed downward to the pump to thus start the next cycle of the liquid circulation.

While the soybeans move in the above-mentioned closed circuit, they are ground by rubbing against each other and the vessel wall under the impact of the pump pressure, cavitation included, and under the turbulent shear forces in the structural member.

After each cycle of the circulatory motion, the temperature of the material being processed gets 0.2° C. to 0.3° C. higher (self-warming up) and, in the range of 280 to 450 cycles (n), runs as high as 100° C. to 112° C. which is required to inactivate trypsin inhibitor.

The number of cycles is a function of operating limits of the apparatus and physical and mechanical properties of the mixture to be processed:

$$n = \frac{ρ \cdot c \cdot Δ t}{η \cdot p} , where$$

ρ is the density of the material to be processed, kg/m³;

c is the specific heat of the material to be processed, m^{2/}c^{2.}° C.;

t is the heating of the material to be processed, ° C.;

P is the pressure generated by the pump, kg/m·c²;

η is the efficiency of the pump.

It has been experimentally found according to biochemical analyses of the products produced by prior art methods that attempts to inactivate trypsin inhibitor to undangerous levels (45 mg per 1 g of protein) have not met with success where the number of circulation cycles “n” is less than 280, the specified number corresponding to 100° C. of the material being processed (the initial temperature being 15° C. to 20° C.).

To prevent the thermal breakdown of amino acids and vitamins, the upper limit of the range of “n” circulation cycles is 450, what corresponds to 112° C. of the material being processed, with the initial temperature being 15° C. to 20° C.

Within 1 to 10 seconds after a stable funnel-shaped depression has been formed in the whirling material where gases previously dissolved in the water used in this process (air, chlorine) and those introduced with the soybeans are released in the process, water is added to the vessel until the gases are expelled from the vessel.

Gas bubbles present in the processed material damp “micro-impacts” on the soybeans thus affecting their reduction in size, while oxygen of the air oxidizes fats and vitamins and impairs organoleptic qualities as well as medicinal and disease preventive properties of the product.

The material is further processed following the step of degassing. Subsequent to the completion of the hydrodynamic mixing when the temperature of the material has been raised to 100° C. to 112° C., the pump is shut off and the product is held for 5 to 30 minutes in the vessel to ensure that protein flavor be got rid of and that trypsin inhibitor eventually be inactivated.

Prepared paste 2C is then discharged for packaging or subjected to natural or forced cooling. The paste can be packaged when hot as for producing various canned products. The method of the invention is further described by way of the following examples of preparing soybean paste 2C of various concentrations, which examples are for illustrative purposes only and are not to be construed as limiting the scope of the invention defined by the appended claims.

### EXAMPLE 1

To prepare paste containing 16% by weight of soybeans, i.e., with the water-soybeans weight ratio of about 1:5.5, the following process conditions were defined: mean density of the material to be processed was 1.07×10³ kg/m³, specific heat “c” was 3.7×10³ m²/c²·° C., the heating-up (Δt) of the material to be processed was 90° C., the pressure (P) generated by the pump was 1.08×10⁶ kg/m·c², and the efficiency (η) of the pump was 0.7. The number of cycles was calculated as 308.

The resulting soybean paste 2C was a highly homogeneous product (the characteristic particle size of dietary fiber as the hardest to process constituent was 10 μm at most) having a somewhat sweet taste free from the taste of soybeans and yellowish in color, owing to which characteristics it can be considered as a product of high organoleptic qualities.

Tests conducted at the Center for Biological Evaluations of the Institute of Biochemistry of the National Academy of Sciences of Ukraine (Kyiv) have shown the degree of vitamin availability (k) to be considerably greater than one, i.e., the vitamin “yield” in the paste was higher than the content of the same vitamins found naturally in soybeans.

Since human organism absorbs useful components, vitamins included, from a saline, there is no escape from the conclusion that the constituents of soybeans are biologically more available. This in its turn is a precondition for better absorbency, in this instance, of soybeans as such.

According to the analyses, the contents of amino acids and fats found naturally in soybeans were retained in the paste of the invention. Trypsin inhibitor was inactivated to an undangerous level (23.2 mg per 1 g protein). The degree of vitamin availability (k) was significantly greater (see Table 1). For example, the yield of vitamin PP (Niacin) was 3.3 times greater compared to the content of the vitamin naturally found in soybeans.

TABLE 1
Vitamin content

| | | | Soybean | Degree of vitamin |
|---|---|---|---|---|
| | | Soybeans (M₁), | paste (M₂), | availability, |
| Vitamin | | mg per 100 g | mg per 100 g | k = M₂/M₁ |
| 1. | Vitamin B₁ | 0.97 | 1.29 | 1.3 |
| 2. | Vitamin B₂ | 0.11 | 0.56 | 5.1 |
| 3. | Vitamin PP | 4.08 | 13.56 | 3.3 |
| | (Niacin) | | | |
| 4. | Vitamin B₆ | 0.83 | 2.28 | 2.7 |
| | (Pyridoxine) | | | |
| 5. | Folic acid | 0.19 | 0.3 | 1.6 |
| 6. | Carotenoids | 0.98 | 2.38 | 2.4 |

As can be seen in Table 2, the weight proportion of polyunsaturated fatty acids (59.4%) is consistent with that in raw soybeans (59.7%), and proportions of linolic acid and linolenic acid were also retained.

TABLE 2
Fatty acids content

| Acid, wt. %, mg per 100 g of dry matter | Soybeans | Paste |
|---|---|---|
| Linolic acid | 52.06 | 51.83 |
| Linolenic acid | 7.64 | 7.57 |
| Polyunsaturated fatty acids, total | 59.7 | 59.4 |

### EXAMPLE 2

To prepare paste containing 20% by weight of soybeans, the following process conditions were defined:

ρ=1.1×10³ kg/m³;

c=3.6×10³ m²/c²·° C.;

Δt=85° C., P=1.41∴10⁶ kg/m·c², η=0.6;

The number of cycles n=398.

The product thus obtained was characterized by high indicators of quality. Trypsin inhibitor was inactivated to an undangerous level, i.e., 30.2 mg per 1 g protein, what is 7 times lower than that in the raw soybeans.

### EXAMPLE (COMPARATIVE)

The paste was prepared as in Example 2 except that the temperature rise was 55° C. (e.g., from 55° C. to 110° C.) and the calculated number of cycles was 257.

The product thus obtained was too gritty with the smell of raw soybeans and with a proteinaceous taste. The content of trypsin inhibitor was only 1.5 times lower, which is not a safe level to use such product for food.

### EXAMPLE (COMPARATIVE)

The paste was prepared as in Example 2 except that the temperature rise was 100° C. (heating up from 30° C. to 130° C.) and the calculated number of cycles was 468.

The product thus obtained split to separate a layer of fat. The average content of vitamins in it was twice as low. Percentages of amino acids were noticeably changed, suggesting that protein decomposed. The product is unusable as food.

The method of the invention compared to that disclosed in Russian Patent No. 2,207,449 “Device for acting upon a fluid flow” issued upon application No. 2001122036 of Aug. 8, 2001 (inventor S. B. Osipenko) consumes less energy —there are 1.8 kg to 2 kg of soybeans processed for every 1 kWh of energy input against 1.2 kg to 1.3 kg. The paste of the invention containing from 12% to 13% by weight of soybeans is creamy, that containing from 14% to 25% by weight of soybeans is like a meat paste, and that containing from 25% to 33% by weight of soybeans is like crystallized honey, thereby providing great scope for varying the form of a final product to please the consumer.

Soybean paste 2C can be recognized on the market of food commodities by an increased content of natural vitamins, especially vitamins B₂ and PP. It should be noted that literature values (mg/100 g) of vitamins contained in soybeans are limited to (0.94-1.28) of vitamin B₁, (0.21-0.23) of vitamin B₂, (0.39-0.91) of vitamin B₆, and (2.2-3.4) of vitamin PP (cf. TOKapeBa H. “ [symbol] OKTOp CO [symbol] , KOpM [symbol] a CO [symbol] ”, M. 2000, crp. 126—Tokareva, N. “Soy, the Doctor; Soy, the Food Provider,” Moscow 2000, page 126 (in Russian)).

It is significant that to recognize soybean paste 2C, no information about the soybeans used in the product is required. That is why vitamins B₂ and PP have been chosen as identifiers of the soybean paste of the invention.

1. Soybean paste 2C as a suspension of finely divided soybeans in water, the suspension comprising proteins, fats, polyunsaturated fatty acids included, carbohydrates, vitamins and microelements, wherein the water-soybeans weight ratio based on moisture-retaining power of proteins being 1:(2-6) and vitamin availability, k=M₂/M₁, in terms of the dry weight of the paste being k>1, wherein M₁ is the content of a vitamin in soybeans and M₂ is the content of the vitamin in the soybean paste.

2. Soybean paste 2C of claim 1 wherein the content of vitamin PP per 100 g of dry product is at least 6.0 mg.

3. Soybean paste 2C of claim 1 wherein the content of vitamin B₂ per 100 g of dry product is at least 0.35 mg.

4. Soybean paste 2C of claim 2 or claim 3 wherein the content of fats containing from 55% to 62% by weight of polyunsaturated fatty acids is constant compared with the content of fats found naturally in soybeans.

5. A method for preparing soybean paste 2C by exposing unprocessed soybeans in a liquid to hydrodynamic forces for 280 through 450 cycles while circulating the soybeans with the liquid in a closed forced circulation air-tight circuit comprising a vessel, a pump, and a structural member and causing turbulence and cavitation in the liquid, and periodically degassing the circulation circuit, whereby a heated suspension is produced.

6. The method of claim 5 wherein the step of degassing comprises the steps of depressurizing the vessel and the step of expelling the gas occurring in the vessel by adding a liquid into the vessel, and the step of degassing is carried out after a period of one second to ten seconds of exposing the soybeans in the liquid to hydrodynamic forces.

7. The method of claim 5 wherein the suspension having attained the temperature of 100° C. to 112° C. is held in the air-tight vessel for 5 to 30 minutes, whereafter the suspension is discharged for packaging or subjected to natural or forced cooling.
